(19) United States
(12) Patent Application Publication
(10) Pub. No.: US 2009/0030576 A1
(43) Pub. Date: Jan. 29, 2009

(54) METHOD AND DEVICE FOR DETECTING THE POSITION OF AN OCCUPANT OF A VEHICLE SEAT

(75) Inventors: Stephanie PERIOT, Paris (FR); Jean-Marc POINSIGNON, Fouligny (FR); Julien HINTZY, Plaisir (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy-Villacoublay (FR)

(21) Appl. No.: 11/829,741

(22) Filed: Jul. 27, 2007

(51) Int. Cl. B60R 21/015

(52) U.S. Cl. 701/45

(57) ABSTRACT

The method includes the following steps:
a) the forces applied to the seat by the occupant are measured at several measurement locations (D, R, S, G) in the seat (1),
b) the measured values of said forces are correlated, and
c) the measured values are compared to reference values, which are obtained by measuring the forces applied at said measurement locations (D, R, S, G) when the occupant is in a nominal position on the vehicle seat (1),
d) the “empty seat” measurements are calibrated in order to monitor variations due to influential parameters.

Motor vehicle safety systems. Motor vehicle comfort feature adjustment systems.

The present invention concerns a method and a device for occupant position detection for a vehicle seat, in particular a motor vehicle seat. The method and the device of the invention relate to the field of passive safety, in particular the field of occupant detection and classification devices for a motor vehicle seat.

Distinguishing among the positions or postures of the occupant of a vehicle seat, there are, on the one hand, the so-called nominal positions, along with the positions derived from said nominal positions, which are the usual driving positions, and on the other hand, the so-called non-nominal positions, also known as “OOP”, which stands for “Out Of Position”.

The installation of passive safety systems inside motor vehicles has largely been motivated by the establishment of laws in the 1980s, particularly in the United States of America, requiring auto makers to offer consumers improved safety solutions.

The first generation airbags are now increasingly being replaced by intelligent systems better suited to needs by analyzing the parameters of the accident and the physical characteristics of the occupant. The speed and force of airbag inflation are tailored to accommodate the occupant and the actual accident conditions. American regulation FMVSS 208 (Federal Motor Vehicle Safety Standard), a regulation to protect occupants of vehicles, requires the deactivation of the passenger seat airbag in certain cases. More precisely, certain non-nominal positions cited in this regulation FMVSS 208 define a zone in which the deactivation of the airbag may be applicable.

Thus, it becomes necessary to characterize the position of the occupant in order to customize the passive safety protection strategies (airbag) or the comfort features (postural comfort, thermal comfort, etc.)

According to prior art, the Applicant uses pressure sensing layers in some of its vehicles in order to detect the presence of a passenger, in particular, IEEE (International Electronics and Engineering) pressure sensing layers, built into the inner padding of seats. The key component of such a layer is a sandwich of heat-stabilized polyimide films, on which electrodes and pressure-sensitive components are imprinted. Each of the sensors modifies its electrical resistance as a function of the pressure on it. These data then enable a measurement system to calculate a pressure profile, automatically correcting for the effects of vehicle movement and the changes in position of the person sitting on the seat. Such a solution, however, entails considerable integration constraints (structure, comfort, design, etc.) and a cost added to the product. Furthermore, by their design and integration, these pressure sensing layers do not make it possible to determine the position of the occupant, and under certain conditions of use they do not even fulfill their detection function. This is the case, for example, when an occupant is sitting on the front edge only of the seat pan.

There are many airbag systems that use sensors, such as the system disclosed in PCT patent No. WO 98/41424, for example, in which the passenger seat of the vehicle has a frame and a string network attached to the frame to support the weight of an occupant on the seat. The system further includes a sensor coupled to a part of the string network that measures a tensile stress exerted on the network by the weight of the seat occupant and transmits a signal representing this stress. There is also a computer connected to the sensor output that produces an airbag deployment control signal when the tensile stress reaches a predetermined threshold value. Such a system does not make it possible to determine the position of the occupant.

The Applicant has also developed a method and a device for occupant detection and classification for a vehicle seat that does not use a sensor. The seat has at least one displacement adjustment controlled by at least one actuator, and the method includes the following steps:
a) the seat displacement actuator is controlled using a predefined increasing power profile, with the power having at least one characteristic representing the torque applied to the shaft of the motor,
b) the startup movement of the actuator is detected, and the value of the variable power characteristic is recorded at that moment,
c) the value of the recorded characteristic is compared to a series of predetermined reference values for the characteristic, in order to determine the presence of an occupant on the seat and classify him according to his weight.

This method, which uses information from electrical seat actuators, does not make it possible to detect the position of the occupant, either.

For vehicle occupant position detection, various characterization devices are known that use vision systems. But such devices lead to problems with cost, design and integration.

Such systems known to prior art entail considerable integration constraints (comfort, design, etc.) and a cost added to the vehicle. Moreover, these systems do not distinguish between various types of occupation, and thus cannot classify the occupant according to various categories.

A first purpose of the present invention is to devise a method and a device for occupant position detection for a vehicle seat, in particular for a motor vehicle.

A second purpose of the present invention is to devise a method and a device for occupant position detection for a vehicle seat that meets the regulatory standards for the detection, classification and characterization of occupants, such as the previously cited American regulation FMVSS 208.

A third purpose of the present invention is to devise a method and a device for occupant position detection for a vehicle seat that, unlike the currently known methods and devices, does not entail cost, design and integration problems.

Another purpose of the present invention is to devise a method and a device for occupant position detection for a vehicle seat that not only makes it possible to tailor the passive safety protection strategies inside a vehicle, but also to adjust the occupant comfort features.

Another purpose of the present invention is to devise a method and a device for occupant position detection for a vehicle seat that that can be applied without burdensome modifications to vehicles equipped with seats with electrical position control.

Yet another purpose of the present invention is to devise a method for occupant position detection using dependable, low-cost measures without lowering the quality of passenger comfort.

In order to achieve these goals, the invention proposes a new method for occupant position detection for a vehicle seat that includes the following steps:
a) the forces applied to the seat by the occupant are measured at several measurement locations in the seat,
b) the measured values of said forces are correlated, and
c) the values thus measured and correlated are compared to reference values, which are obtained by measuring the forces applied at said measurement locations when the occupant is in a nominal position on the vehicle seat.
d) the “empty seat” measurements are calibrated in order to monitor variations due to influential parameters such as seat wear, temperature, input voltage, etc.

According to a first embodiment of the invention, the forces applied by the occupant to the seat are measured at several measurement locations in the seat using force sensors placed at said measurement locations.

According to a preferred mode of embodiment of the invention, the seat is equipped with several electric actuator-controlled displacement settings, and the forces applied by the occupant to the seat are measured using electrical information from an electrical seat adjustment actuator for each of the locations, with said electrical information representing the force supplied in order to perform an imperceptible displacement of the seat at this location.

Said electrical information can be the average current used by the corresponding adjustment actuator, or the peak current at the startup of said actuator, or this electrical information can be obtained by analyzing the current variance of said actuator or by harmonic analysis of the current of said actuator.

Said information can also be the rotation period of the corresponding adjustment actuator, or, as developed by the Applicant, the measurement of the minimum power required to perform a micro-displacement of the seat at the given location.

According to a mode of embodiment of the invention given as an example, said measurement locations are four in number, namely:
a backrest location, on the upper front part of the backrest,
a seat track location, on the front face of the seat pan,
a height adjustment location, on the rear part of the upper surface of the seat pan, and
a tilt adjustment location, on the fore part of the upper surface of the seat pan.

By preference, then, when there are four locations at which the forces applied by the occupant to the seat are measured, electrical information coming from the seat backrest, tilt, height and track adjustment actuators is used.

As a variant, there can be more than four locations at which the forces applied by the occupant to the seat are measured, and in this case, electrical information from all of the seat adjustment actuators can be used. All of the controlled seat movements are capable of providing electrical information of use in determining the position of the occupant on the seat. In accordance with the principle of the present invention, it is not advisable to limit the concept to the four movements mentioned above.

The reference values, mentioned previously, are obtained by measuring the forces applied at said measurement locations when the occupant buckles the seat belt.

Preferably, calibration measurements are taken as well, with the seat empty, in order to monitor the variations due to various variable parameters that can have an influence on the measurements, such as seat wear, temperature, input voltage, etc.

Also preferably, the method of the invention is repeated periodically, so as to determine the immediate position of the occupant.

The present invention also provides a new device for occupant position detection for a vehicle seat, for implementing the method of the invention, which device has devices situated in several measurement locations on the seat to measure the force exerted by the occupant on the seat; means for transmitting said force measurements to a computing unit, which computing unit correlates the measurements, compares them with reference values, and produces a signal characterizing the position of the seat occupant that can be used by the passive safety means of the vehicle and/or the comfort feature adjustment means of the vehicle.

According to a preferred embodiment of the device of the invention, which is meant for a seat having several electric actuator-controlled displacement adjustments, the device includes:
for each displacement adjustment, means for measuring the value of an actuator power characteristic representing the force exerted by the occupant on the seat,
means for transmitting said measurements of the measured values to a computing unit, which correlates and compares said measured values with reference values, and produces a signal characterizing the position of the seat occupant that can be used by the passive safety means of the vehicle and/or the comfort feature adjustment means of the vehicle.

By preference, said locations, also referred to as “strategic locations”, are four in number, namely:
a backrest location, on the upper front part of the backrest,
a seat track location, on the front face of the seat pan,
a height adjustment location, on the rear part of the upper surface of the seat pan, and
a tilt adjustment location, on the fore part of the upper surface of the seat pan.

Also according to the preferred embodiment, said displacement adjustments controlled by electric actuator are the seat backrest, tilt, height and track adjustments.

Other purposes, advantages and characteristics of the invention will appear in the following description of a preferred, non-limiting embodiment of the object and scope of the present patent application, accompanied by drawings in which:

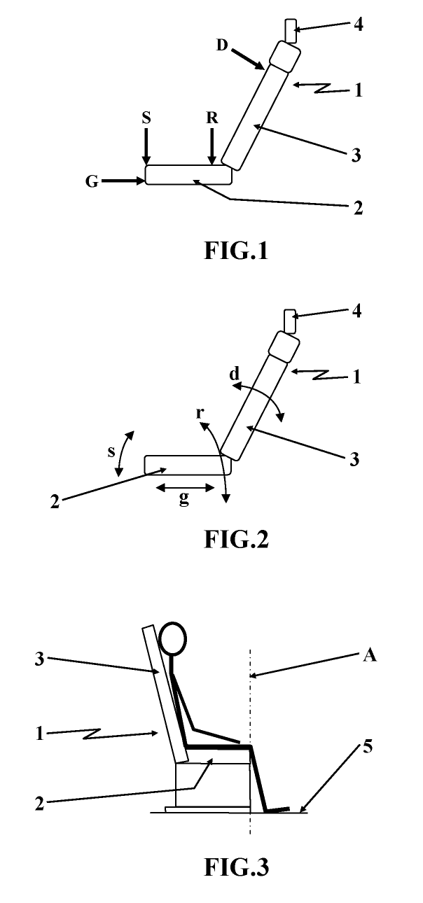

FIG. 1 is a schematic representation of a vehicle seat showing the so-called “strategic” locations for measuring the force applied to the seat, in order to illustrate the principle of the invention,

FIG. 2 is a schematic representation of a vehicle seat, illustrating the seat movements used in measuring the forces applied to the seat, also in order to illustrate the principle of the invention,

FIG. 3 is a very schematic representation of the nominal position of an occupant on the seat,

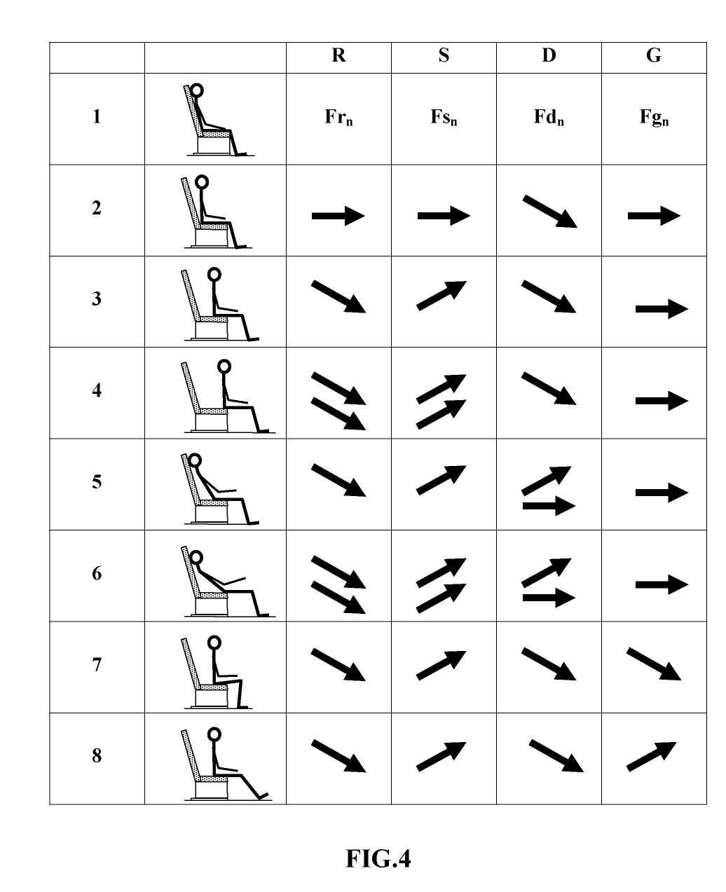

FIG. 4 is a table showing the variations detected in the measurements at the strategic locations on the seat, according to various positions of the occupant,

FIG. 5 represents schematically the three positions of the seat occupant tested in an example with figures of an implementation of the method according to the invention,

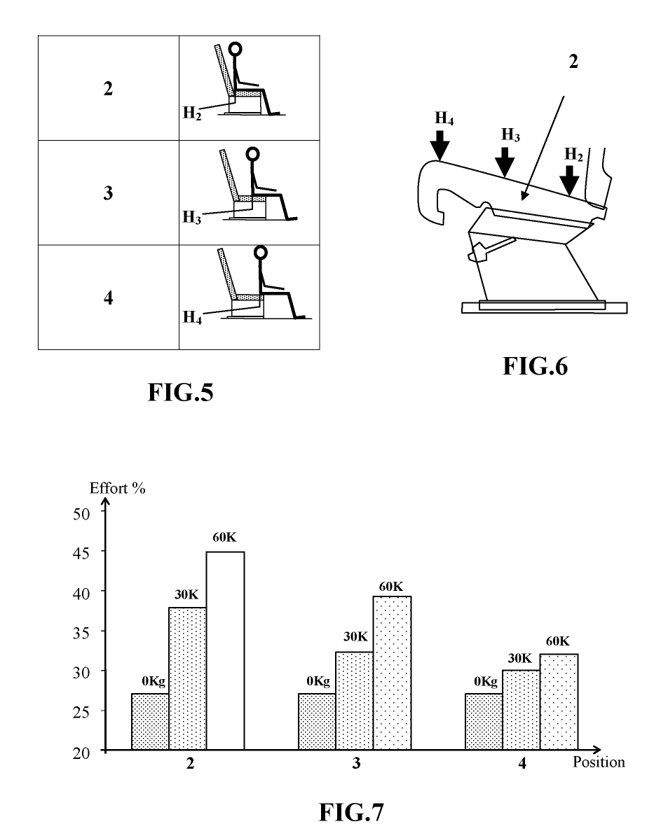

FIG. 6 schematically represents the bearing points on the seat for the three occupant positions in FIG. 5,

FIG. 7 shows the forces measured at the height adjustment location according to the position of the bearing point in FIG. 6, in the implementation example of the method of the invention illustrated in FIGS. 5 and 6,

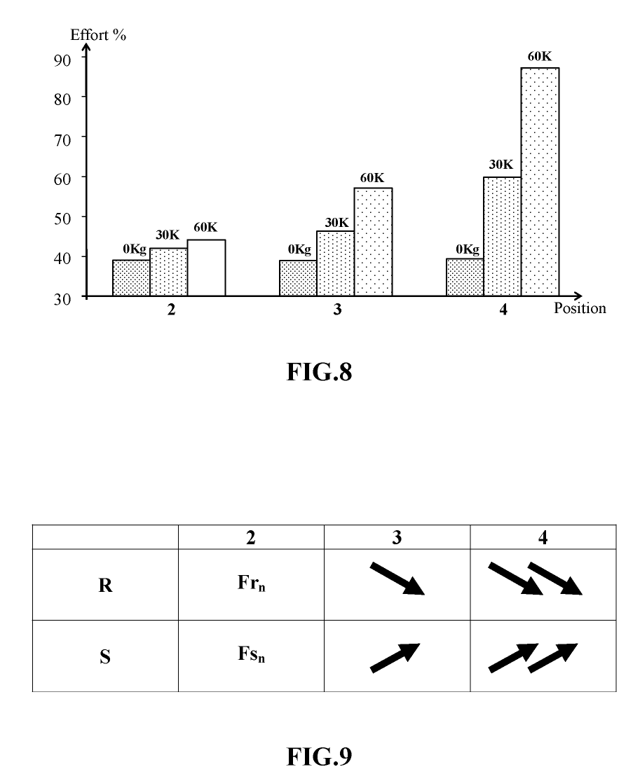

FIG. 8 represents the forces measured at the tilt adjustment location according to the position of the bearing point in FIG. 6, in the implementation example of the method of the invention illustrated in FIGS. 5 and 6,

FIG. 9 is a table summarizing the results of the implementation example of the method of the invention illustrated in FIGS. 5 to 8.

In the drawing of FIG. 1, a seat 1 is very schematically represented, including a seat pan 2 and a backrest 3, as well as a headrest 4. The arrows D, R, S and G indicate the locations at which the forces applied to the seat 1 are measured, as well as the direction in which these forces are measured (shown by the direction of the representative arrow vectors). In the present embodiment of the invention, given as a nonlimiting example of the object of the invention, four locations have been selected, known as “strategic locations”, which are the following:
D: Backrest location
R: Height adjustment location
S: Tilt adjustment location
G: Track location

Generally speaking, the principle of the invention consists in detecting the forces applied at the strategic locations D, R, S and G on the seat, and then determining the position of the occupant by correlating the forces thus measured and comparing them to a reference measurement.

In order to do this, force sensors are placed at the strategic locations D, R, S and G.

As a variant, an electrical information unit I can be used that comes from the seat actuators, representing the force supplied in order to perform an imperceptible displacement.

The electrical information unit I can be obtained by various methods. It can be obtained by analyzing the electrical parameters of the electric seat actuators or from their modulated control.

When the information unit I is thus obtained by analyzing the electrical parameters of the seat actuators, it can be the average current used by the actuator or the peak current at the startup of the actuator, or the result of analyzing the current variance, or the result of harmonic analysis of the current spectrum of the actuator.

When the information unit I comes from the modulated control of the electric seat actuators, it can be obtained by measuring the rotation period of the actuator or by detecting the minimum power required to perform a micro-displacement of the actuator. In this latter method, the electric seat actuator (electric motor) is controlled using a predefined power ramp, with the power having at least one variable characteristic (the cyclical ratio of a chopped voltage) representing the torque applied to the shaft of said motor; the startup rotation of the electric actuator motor shaft is detected, and at that moment, the value of said variable characteristic of the current is recorded.

In order to measure the forces detected at the four strategic locations previously mentioned as an example, the four corresponding seat movements are used, which are illustrated schematically by the arrows in the drawing in FIG. 2, namely:
d: backrest inclination movement,
r: seat height movement,
s: seat tilt movement,
g: fore-aft adjusting movement along the tracks.

Although in the present embodiment of the invention, given as a nonlimiting example of the object of the invention, there are four electrical seat movements, each of which provides an electrical information unit that is of use in detecting the position of the occupant, all of the electrical movements of the seat can be used, with no limit to their number, without deviating from the principle and scope of the present invention.

As previously mentioned, a reference measurement must be defined, to which value the values of the measurements taken at the strategic locations are compared. This reference measurement corresponds to the nominal position of the occupant, represented schematically in the drawing in FIG. 3, in which the occupant is sitting normally on the seat pan 2, with his back materially in contact with the front surface of the backrest 3, his feet on the vehicle floor 5 and his legs inclined from the vertical axis A running down the front edge of the seat pan 2 of the seat 1, roughly in line with the occupant's knees. This reference measurement is taken at the moment the seatbelt is buckled. “Empty seat” measurement calibrations are also performed in order to monitor the variations due to influential parameters such as seat wear, temperature, input voltage, etc.

By taking measurements periodically and comparing them with the reference measures, it is possible to determine the instantaneous position of the occupant. The table in FIG. 4 shows the variations detected in the height, tilt, backrest and track measurements for eight occupant positions or postures, numbered 1 to 8 in the first column of the table. The table in FIG. 4 gives schematic representations for all of these positions (column 2) and the variations in force at the four strategic locations, namely the height (R), tilt (S), backrest (D) and track (G) “strategic locations”.

Position 1 is the nominal reference position, represented by the nominal force values Frₙ, Fsₙ, Fdₙ et Fgₙ at the height R, tilt S, backrest D and track G locations, respectively.

Position 2 is a position in which the occupant inclines his upper body forward; consequently, the force on D, the backrest, shows a marked negative change, since the occupant's back is no longer in contact with the backrest 3 of the seat 1. The other measurements, namely at the height R, tilt S and track G locations, are not affected.

In position 3, the occupant not only inclines his upper body forward as in position 2, but moves his whole body forward so that he is sitting on roughly the front half of the seat pan 2 of the seat 1; consequently, with respect to position 2, two additional changes appear: a negative change at R and an inverse, positive change at S.

In position 4, the occupant continues moving as in position 3 until his body is bearing on the front edge of the seat pan 2 of the seat 1; consequently, the changes are in the same direction as for position 3, but with higher absolute values at R and S.

In position 5, the occupant moves his whole body forward to bear on roughly the front half of the seat pan 2 of the seat 1 and additionally, rests his head on the backrest 3; consequently, the changes are roughly those of position 3, except that the force on D is the nominal force or a greater force, because the occupant's head is “supported” by the backrest 3 of the seat 1.

In position 6, the occupant continues moving as in position 5 until his body is bearing on the front edge of the seat pan 2 of the seat 1, with his head still supported by the backrest 3; consequently, the changes are in the same direction as in position 5, but with higher absolute values at R and S.

In position 7, the occupant inclines his upper body forward and moves his whole body forward to bear on roughly the front half of the seat pan 2 of the seat 1 as in position 3, but in addition, draws his legs up, roughly along the axis A in FIG. 3; consequently, there is a negative change at G with respect to position 3.

Position 8 is the same as position 7, except for the legs, which are not drawn up, but pushed forward; consequently, the change at G is the reverse of that for position 7, that is, a positive change with respect to the nominal force Fgₙ.

Measurements were taken by the Applicant in order to illustrate the principle of the present invention with figures. They were taken from the tilt and height adjustment motors, as a function of the load bearing point on the seat.

The table in FIG. 5 shows these different bearing points H₂, H₃ and H₄, which correspond to the three numbered positions 2, 3 and 4, respectively, in FIG. 4. These three positions correspond to the three different bearing points of the occupant on the seat pan, namely H₂ in position 2 (the occupant sitting on the whole seat pan), H₃ in position 3 (the occupant sitting on the front half of the seat pan) and H₄ in position 4 (the occupant sitting on the front edge of the seat pan), the other parameters of the position remaining unchanged. The bearing points H₂, H₃ and H₄ for positions 2, 3 and 4, respectively, are schematically represented on a seat pan 2 in the drawing in FIG. 6.

For each of the positions labeled 2, 3 and 4 in FIG. 5, the forces measured at the height adjustment R with a zero load (0 kg), with a load of 30 kg and with a load of 60 kg have been represented. The values of the forces measured at the height adjustment are shown on the graph in FIG. 7 as a percentage of the force applied.

So for example, in position 2, that is, the position in which the occupant is sitting on the entire seat pan (bearing point H₂), the forces measured at the height adjustment with a zero load, a 30 kg load, and a 60 kg load are respectively about 30%, about 38% and about 45% of said loads, respectively. The same measurements are taken for positions 2 and 3, and for each of these positions for the same loads at the bearing points H₃, H₄, respectively.

Likewise, for each of the positions 2, 3 and 4, the forces measured at the tilt adjustment S have been shown in FIG. 8 under the same conditions, that is, with a zero load (0 kg), with a load of 30 kg and with a load of 60 kg. The forces measured are likewise indicated as a percentage of the force applied.

FIG. 9 is a table representing the summary of the measurements in FIGS. 7 and 8. Column 2 shows the forces applied, which are the nominal forces Frₙ and Fsₙ at the height adjustment R and at the tilt adjustment S, respectively. Columns 3 and 4 correspond to positions 3 and 4, with bearing points H₃ and H₄, respectively. The variations at the height adjustment and at the tilt adjustment are in the same direction for both positions 3 and 4, but their absolute values are higher for position 4, which corresponds to the bearing point H₄ at the front edge of the seat pan 2 of the seat 1.

Thus, the position of the bearing point is representative of the force detected on the seat's height adjustment motor and tilt adjustment motor. By comparing the measurements taken at the four seat motors in this way, it is possible to determine the position of the occupant by the variations illustrated in the table in FIG. 4.

The invention also provides an occupant position detection device for a vehicle seat for the implementation of the method thus described.

According to a first embodiment of this device, it has sensors to measure the force exerted by the occupant on the seat 1, which sensors are situated at several measurement locations on the seat 1, for example, the “strategic locations” previously mentioned and labeled D, R, S and G in the drawing in FIG. 1. The device also includes means for transmitting the force measurements obtained with these sensors to a computing unit (not shown), of a type known per se, which correlates the measurements taken using the method described above, compares them with reference values and produces a signal characterizing the position of the seat occupant, which can be used by the passive safety means of the vehicle and/or the comfort feature adjustment means of the vehicle.

According to a preferred embodiment, applied to a seat 1 that has several actuator-controlled displacement adjustments d, r, s and g, as illustrated in FIG. 2, the device includes:
for each displacement adjustment d, r, s and g, means for measuring the value of a variable electric actuator power characteristic representing the force exerted by the occupant on the seat 1,
means for transmitting said measured values to a computing unit, which correlates the measurements and compares them with reference values, and produces a signal characterizing the position of the occupant of the seat 1, which can be used by the passive safety means of the vehicle and/or the comfort feature adjustment means of the vehicle.

As already mentioned with respect to the method, the variable electric actuator power characteristic representing the force exerted by the occupant on the seat can be the average current used by said adjustment actuator or the peak current at the startup of the adjustment actuator, or it can be obtained by variance analysis or by harmonic analysis of the current of the adjustment actuator. It can also be the rotation period of the adjustment actuator or the minimum power required to perform a micro-displacement of the seat at the given location.

The computing unit can conveniently be the on-board computer of the vehicle, programmed in a manner known per se to perform the correlations and comparisons of the method of the invention, as exemplified in the above description.

Lastly, note that the present invention meets the regulatory standards pertaining to occupant detection, classification and characterization (for example, the previously mentioned American standard FMVSS 208). Knowing the position of the occupant on the vehicle seat makes it possible to tailor the various implementation strategies for the restraining and safety means (airbags, seatbelts) according to the conditions of use, for example, for the front airbag:
Activation/Deactivation
Activation/Low risk deployment
Activation/Low risk deployment/Deactivation

Furthermore, the information on the position of the occupant, as obtained by the present invention, makes it possible to customize the postural comfort settings, such as the automatic seat and massage function settings, the thermal comfort settings, such as the driver and/or passenger air-conditioning settings, seat ventilation, or settings for other functions or devices, such as the headlight tilt settings or mirror position settings, etc.

1. Method for occupant position detection for a vehicle seat, which includes the following steps:
a) the forces applied to the seat by the occupant are measured at several measurement locations in the seat,
b) the measured values of said forces are correlated, and
c) the measured and correlated values are compared to reference values, which are obtained by measuring the forces applied at said measurement locations when the occupant is in a nominal position on the vehicle seat.
d) and the “empty seat” measurements are calibrated in order to monitor variations due to influential parameters.

2. Method according to claim 1, wherein the forces applied by the occupant to the seat are measured at several measurement locations in the seat using force sensors placed at said measurement locations.

3. Method according to claim 1, the seat being equipped with several electric actuator-controlled displacement adjustments wherein the forces applied by the occupant to the seat are measured at several measurement locations in the seat, using an electrical information originating from an electrical seat adjustment actuator for each of the locations, with said electrical information representing the force supplied in order to perform an imperceptible displacement of the seat at this location.

4. Method according to claim 3, wherein said electrical information is the measurement of the average current used by said corresponding adjustment actuator.

5. Method according to claim 3, wherein said electrical information is the measurement of the peak current at the startup of said corresponding adjustment actuator.

6. Method according to claim 3, wherein said electrical information is obtained by analyzing the current variance of said corresponding adjustment actuator.

7. Method according to claim 3, wherein said electrical information is obtained by harmonic analysis of the current of said corresponding adjustment actuator.

8. Method according to claim 3, wherein said electrical information is the measurement of the rotation period of said corresponding adjustment actuator.

9. Method according to claim 3, wherein said electrical information is the measurement of the minimum power required to perform a displacement of the seat at the given location that is imperceptible to the occupant.

10. Method according to claim 1, wherein said locations are four in number, namely:
a backrest location, on the upper front part of the backrest of the seat,
a seat track location, on the front face of the seat pan of the seat,
a height adjustment location, on the rear part of the upper surface of the seat pan of the seat, and
a tilt adjustment location, on the fore part of the upper surface of the seat pan of the seat.

11. Method according to claim 3, wherein four is the number of locations at which the forces applied by the occupant to the seat are measured, and in that electrical information originating from the electrical actuators for the seat backrest, tilt, height and track adjustments is used.

12. Method according to claim 3, wherein there are more than four locations at which the forces applied by the occupant to the seat are measured, and in that electrical information originating from all of the electrical seat adjustment actuators is used.

13. Method according to claim 1, wherein said reference values are obtained by measuring the forces applied at said measurement locations when the occupant buckles the seat belt.

14. Method according to claim 1, wherein calibration measurements are taken as well, with the seat empty, in order to monitor the variations due to various variable parameters that can influence the measurements.

15. Method according to claim 1, wherein it is repeated periodically, so as to determine the immediate position of the occupant.

16. Device for occupant position detection for a vehicle seat, for implementing the method according to claim 1, which has sensors to measure the force exerted by the occupant on the seat, situated in several measurement locations on the seat, means for transmitting said force measurements to a computing unit, which correlates the measurements, compares them with reference values, and produces a signal characterizing the position of the seat occupant that can be used by the passive safety means of the vehicle and/or the comfort feature adjustment means of the vehicle.

17. Device for occupant position detection for a vehicle seat, for implementing the method according to claim 1, which seat has several actuator-controlled displacement adjustments wherein said device includes:
for each displacement adjustment, means for measuring the value of an actuator power characteristic representing the force exerted by the occupant on the seat,
means for transmitting said measured values to a computing unit, which correlates the measurements and compares them with reference values, and produces a signal characterizing the position of the occupant of the seat that can be used by the passive safety means of the vehicle and/or the comfort feature adjustment means of the vehicle.

18. Device according to claim 17, wherein said actuator power characteristic representing the force exerted by the occupant on the seat is the measurement of the average current used by said corresponding adjustment actuator.

19. Device according to claim 17, wherein said actuator power characteristic representing the force exerted by the occupant on the seat is the measurement of the peak current at the startup of said corresponding adjustment actuator,

20. Device according to claim 17, wherein said actuator power characteristic representing the force exerted by the occupant on the seat is obtained by variance analysis of the current of said corresponding adjustment actuator.

21. Device according to claim 17, wherein said actuator power characteristic representing the force exerted by the occupant on the seat is obtained by harmonic analysis of the current of said corresponding adjustment actuator.

22. Device according to claim 17, wherein said actuator power characteristic representing the force exerted by the occupant on the seat is the measurement of the rotation period of said corresponding adjustment actuator.

23. Device according to claim 17, wherein said actuator power characteristic representing the force exerted by the occupant on the seat is the measurement of the minimum power required to perform a micro-displacement of the seat at the given location.

24. Device according to claim 16, wherein said locations are four in number, namely:
a backrest location, on the upper front part of the backrest of the seat,
a seat track location, on the front face of the seat pan of the seat,
a height adjustment location, on the rear part of the upper surface of the seat pan of the seat, and
a tilt adjustment location, on the fore part of the upper surface of the seat pan of the seat.

25. Device according to claim 17, wherein said displacement adjustments controlled by electric actuator are the backrest, tilt, height and track adjustments of the seat.

26. Device according to claim 16, wherein said computing unit is the on-board computer of the vehicle.
